(19) United States
(12) Patent Application Publication
(10) Pub. No.: US 2024/0006962 A1
(43) Pub. Date: Jan. 4, 2024

(54) ROTOR FOR A ROTARY ELECTRIC MACHINE

(71) Applicant: VALEO EQUIPEMENTS ELECTRIQUES MOTEUR, Creteil Cedex (FR)

(72) Inventors: Khadija EL BARAKA, Creteil Cedex (FR); Svetislav JUGOVIC, Creteil Cedex (FR)

(73) Assignee: VALEO EQUIPEMENTS ELECTRIQUES MOTEUR, Creteil Cedex (FR)

(21) Appl. No.: 18/251,362

(22) PCT Filed: Nov. 3, 2021
(86) PCT No.: PCT/EP2021/080535

§ 371 Date: May 1, 2023

(30) Foreign Application Priority Data
Nov. 5, 2020 (FR) 20 11355

(51) Int. Cl. H02K 9/06; H02K 1/276; H02K 1/28

(52) U.S. Cl. CPC H02K 9/06; H02K 1/28; H02K 1/276

(57) ABSTRACT

A rotor for a rotary electric machine having an axis of rotation includes a body having cavities includes a first end and a second end that are opposite to each other in the direction of the axis of rotation, and magnets received in the cavities. Also provided is a shaft on which the body is mounted, and a first end disk including a first number of first blades that are able to move a fluid, notably air, from a first radially inner position to a second radially outer position. The first end disk prevents the magnets from exiting the cavities via the first end of the body, and a clamping means presses the first end disk directly or indirectly against the first end of the body.

The invention relates to a rotor for a rotary electric machine with cooling, and to a rotary electric machine equipped with such a rotor.

Patent application US2019386537 discloses a rotor for a rotary electric machine, comprising:
a body comprising cavities and comprising a first end and a second end that are opposite to each other in the direction of the axis of rotation A,
magnets received in the cavities,
a shaft on which the body is mounted,
a first end disk comprising a first number of first blades that are able to move a fluid, notably air, from a first radially inner position to a second radially outer position,
a second end disk comprising a second number of first blades that are able to move a fluid, notably air, from a third radially inner position to a fourth radially outer position.

The first end disk and second end disk are fastened to the shaft but do not enable axial clamping of the rotor. An offset of the rotor body with respect to the end disks is thus possible. This offset may lead to a decrease in the performance properties of the rotary electric machine. In addition, the magnets of the rotor are not held axially in the rotor. They are thus able to move axially with respect to the body. The performance of the electric machine may then be reduced.

The present invention seeks to overcome all or some of these drawbacks.

The invention relates to a rotor for a rotary electric machine having an axis of rotation and comprising:
a body comprising cavities and comprising a first end and a second end that are opposite to each other in the direction of the axis of rotation,
magnets received in the cavities,
a shaft on which the body is mounted,
a first end disk comprising a first number of first blades that are able to move a fluid, notably air, from a first radially inner position to a second radially outer position, the first end disk preventing the magnets from exiting the cavities via the first end of the body,
a clamping means pressing the first end disk directly or indirectly against the first end of the body.

The use of a clamping means makes it possible to avoid the movement of the body with respect to the first end disk. This absence of movement contributes to the holding of the position of the body with respect to a stator of the rotary electric machine. It is thus possible to limit the performance losses of the rotary electric machine that are caused by an offset between the rotor body and the stator. The axial clamping of the end disk against the body also makes it possible to hold the magnets in the cavities. This clamping is also improved through the use of an end disk comprising blades. Specifically, in addition to enabling the movement of a cooling fluid for cooling the rotary electric machine, the first blades enable a rigidification of the first end disk. The axial abutment of the first end disk is thus possible even at a distance from the clamping means.

According to an additional feature of the invention, the cavities are closed in a section perpendicular to the axis of rotation. Consequently, the magnets are buried.

According to an additional feature of the invention, the cavities are disposed in pairwise fashion in the form of a V.

According to an additional feature of the invention, the rotor comprises a second end disk, the clamping means pressing the second end disk directly or indirectly against the second end.

The use of a second end disk pressing, by virtue of the clamping means, against the body makes it possible to improve the holding of the position of the body with respect to a stator of the rotary electric machine. It also makes it possible to hold the magnets in the cavities and prevent them from exiting via the second end.

According to an additional feature of the invention, the second end disk comprises a second number of second blades that are able to move a fluid, notably air, from a third radially inner position to a fourth radially outer position.

The use of blades on the second end disk makes it possible to improve the cooling of the rotary electric machine. It also enables a rigidification of the second end disk. Thus the axial abutment of the second end disk is improved in particular at a distance from the clamping means.

According to an additional feature of the invention, the first number of first blades and the second number of second blades are different and/or the first blades and/or the second blades are distributed circumferentially in an irregular manner.

A different number of first blades and second blades and/or the first blades and the second blades being distributed in an irregular manner makes it possible to reduce the noise generated by the rotary electric machine.

According to an additional feature of the invention, the first end disk comprises a first discoid part from which the first blades extend, the first blades notably being formed integrally with the first discoid part.

The use of first blades formed integrally with the first discoid part makes it possible to improve the rigidity of the first end disk. In addition, such an end disk makes it possible to limit the number of components and to simplify the manufacture and therefore to reduce the cost of the first end disk.

According to an additional feature of the invention, the first end disk has a first thickness in the direction of the axis of rotation and the first discoid part has a second thickness in the direction of the axis of rotation, the ratio between the second thickness and the first thickness being between 0.2 and 0.6.

Such a ratio permits a first discoid part of sufficient thickness to make the machining and balancing of the rotor easier. It also makes it possible to retain good cooling performance properties by virtue of the first blades of sufficient length in the axial direction.

According to an additional feature of the invention, the second end disk comprises a second discoid part from which the second blades extend, the second blades notably being formed integrally with the second discoid part.

The use of second blades formed integrally with the second discoid part makes it possible to improve the rigidity of the second end disk. In addition, such an end disk makes it possible to limit the number of components and to simplify the manufacture and therefore to reduce the cost of the second end disk.

According to an additional feature of the invention, the second end disk has a third thickness in the direction of the axis of rotation and the second discoid part has a fourth thickness in the direction of the axis of rotation, the ratio between the fourth thickness and the third thickness being between 0.2 and 0.6.

Such a ratio permits a second discoid part of sufficient thickness to make the machining and balancing of the rotor easier. It also makes it possible to retain good cooling performance properties by virtue of the second blades of sufficient length in the axial direction.

According to an additional feature of the invention, the shaft comprises a shoulder against which the second end of the body abuts directly or indirectly in the direction of the axis of rotation A, the body being clamped between the clamping means and the shoulder.

Such a shoulder enables precise positioning of the rotor body, of the first balancing disk and, where appropriate, of the second balancing disk with respect to the shaft and therefore with respect to the stator. It is thus possible to improve the performance properties and the cooling of the rotary electric machine.

According to an additional feature of the invention, the shaft comprises a threaded zone and the clamping means is a nut screwed onto the threaded zone.

Such a clamping means makes it possible, due to its central position, to satisfactorily distribute the clamping force between the end disk or disks and the body. It also enables clamping with a very limited number of components.

According to an additional feature of the invention, the clamping means comprises a shank, notably a threaded shank parallel to the axis of rotation A, passing through a hole formed in the body.

The invention also relates to an electric machine comprising:
a stator,
a rotor as described above.

In all of the above, the rotor may comprise any number of pairs of poles, for example six or eight pairs of poles.

In all of the above, the rotary electric machine may have a stator having a polyphase electric winding, for example formed by wires or by conducting bars connected to one another.

The rotary electric machine may comprise a power electronics component that is able to be connected to the on-board network of a vehicle. This power electronics component comprises for example an inverter/rectifier that allows an on-board network of the vehicle to be charged, or that can be electrically powered by this network, depending on whether the rotary electric machine is operating as a motor or as a generator.

The rotary electric machine may further comprise a pulley or any other means of connection to the rest of a powertrain of the vehicle. The electric machine is, for example, connected, notably via a belt, to the crankshaft of a combustion engine of the vehicle. In a variant, the rotary electric machine is connected at other locations in the powertrain, for example at the input of a gearbox with regard to the torque passing toward the wheels of the vehicle, at the output of the gearbox with regard to the torque passing toward the wheels of the vehicle, at the gearbox with regard to the torque passing toward the wheels of the vehicle, or on the front axle assembly or the rear axle assembly of this powertrain.

The invention may be understood better upon reading the following description of non-limiting implementation examples thereof and upon studying the appended drawing, in which:

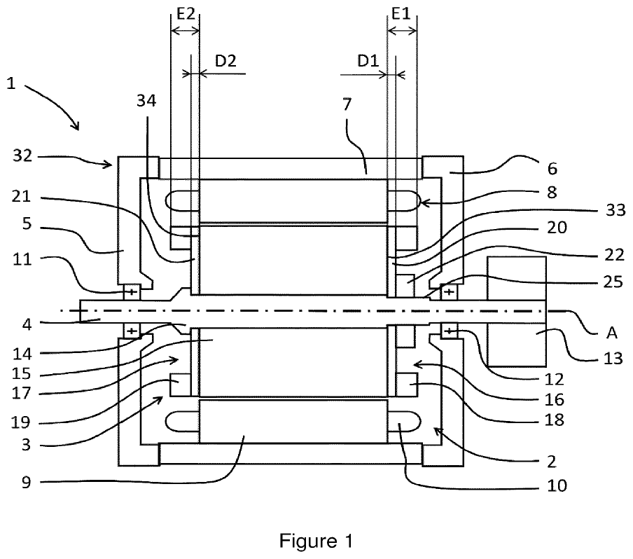

FIG. 1 shows a schematic partial view in section of a rotary electric machine comprising a rotor according to a first embodiment of the invention,

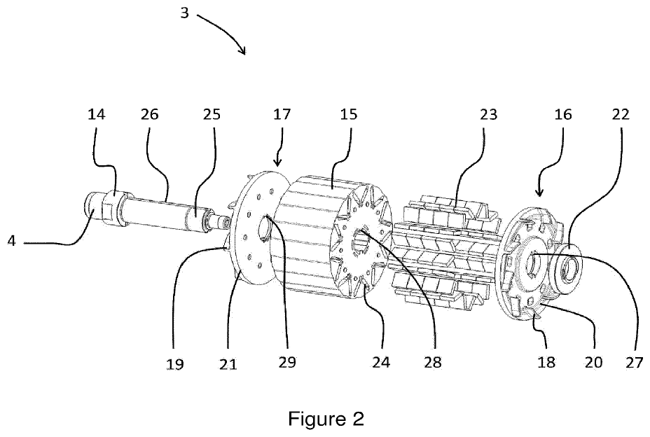

FIG. 2 shows an exploded view of the rotor according to the first embodiment of the invention,

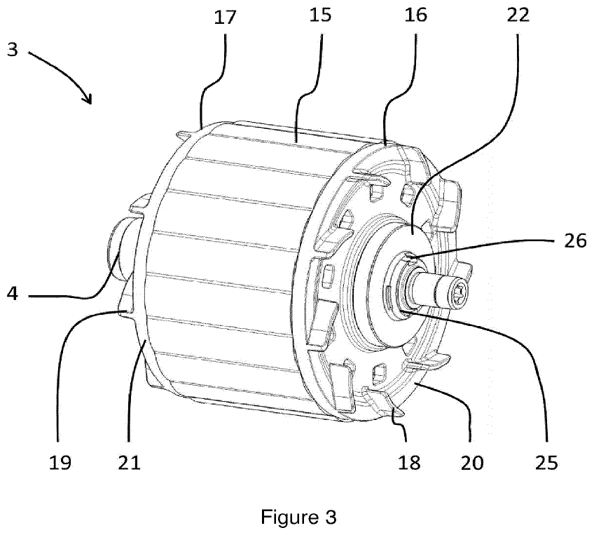

FIG. 3 shows a view of the rotor according to the first embodiment of the invention,

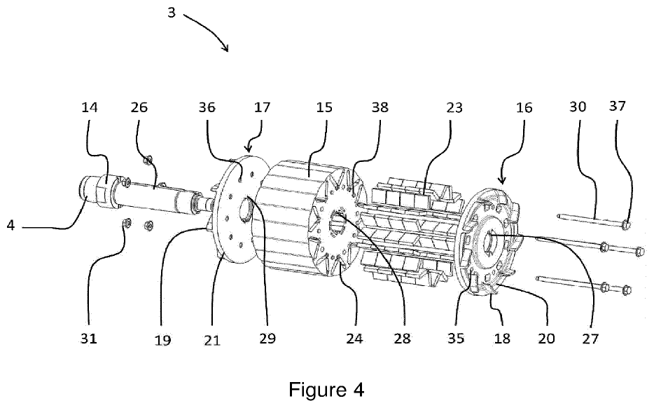

FIG. 4 shows an exploded view of a rotor according to a second embodiment of the invention,

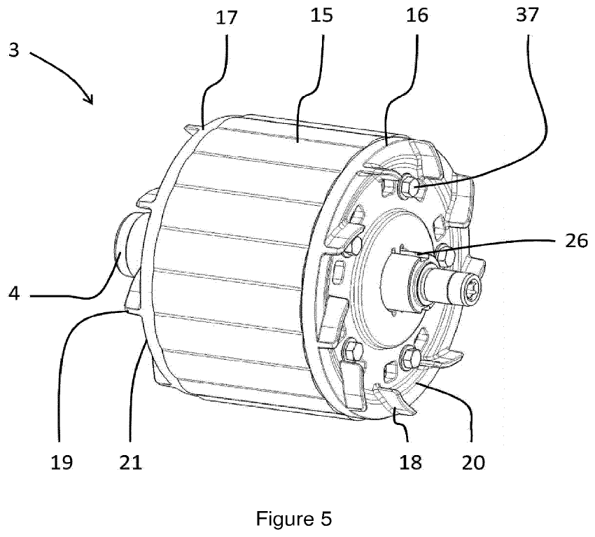

FIG. 5 shows a view of the rotor according to the second embodiment of the invention.

Throughout the figures, elements that are identical or perform the same function bear the same reference numbers. The following embodiments are examples. Although the description refers to one or more embodiments, this does not necessarily mean that each reference relates to the same embodiment, or that the features apply only to one embodiment. Individual features of different embodiments may also be combined or interchanged to provide other embodiments.

FIG. 1 shows a schematic partial view in section of a rotary electric machine 1 having an axis of rotation A according to a first embodiment of the invention. The rotary electric machine 1 comprises a stator 2 and a rotor 3 in a casing 32. The casing comprises, for example, a first bearing carrier 5, a second bearing carrier 6 and a tubular spacer 7. The tubular spacer 7 is for example clamped between the first bearing carrier 5 and the second bearing carrier 6, for example by virtue of tie rods (not shown) between the first bearing carrier 5 and the second bearing carrier 6. The stator is fastened inside the casing 32, for example tightly fitted into the tubular spacer 7.

The stator comprises a stator body 9 and a winding 8. The rotor body 9 comprises for example a stack of magnetic laminations. For example, the winding 8 comprises electrical conductors, of which an active part passes through slots formed in the body 9 and a connecting part or winding overhang 10 is formed outside of the slots. The winding 8 is for example a winding of the hairpin-winding type.

The rotor 3 comprises a shaft with axis of rotation A. The shaft is guided in rotation by a first rolling bearing 11 mounted in the first bearing carrier and a second rolling bearing 12 mounted in the second bearing carrier 6. A drive element 13, for example a pulley or a gear, is fastened to the shaft 4.

In another embodiment that is not shown, the shaft 4 is guided in rotation with respect to the first bearing carrier and to the second bearing carrier by virtue of other known rotation-guiding means, for example plain journal bearings.

The rotor 3 also comprises:
a body 15 which is mounted on the shaft 4 and which comprises cavities 24 and a first end 33 and a second end 34 that are opposite to each other in the direction of the axis of rotation A,
magnets 23 received in the cavities 24,
a first end disk 16 comprising a first number of first blades 18 that are able to move a fluid, notably air, from a first radially inner position to a second radially outer position, the first end disk 16 preventing the magnets 23 from exiting the cavities 24 via the first end 33 of the body 15,
a clamping means 22 pressing the first end disk 16 directly or indirectly against the first end 33 of the body 15.

The body 15 of the rotor comprises for example a stack of magnetic laminations.

The body 15 may comprise a central opening through which the shaft 4 passes.

The cavities 24 extend for example in the direction of the axis of rotation A. In the embodiments of the invention that are shown in the figures, the cavities 24, and therefore the magnets 23, are disposed in pairwise fashion in the form of a V.

In another embodiment that is not shown, the cavities also extend in the direction of the axis of rotation A but have a radial orientation.

In another embodiment that is not shown, the cavities are oriented perpendicularly with respect to a radius of the rotor such that the north pole and the south pole of each magnet are radially opposed. For example, the south pole is oriented toward the axis of rotation, that is to say radially toward the inside, whereas the north pole is oriented radially toward the outside.

The cavities 24 extend for example from the first end 33 to the second end 34 of the body 15.

As seen above, in the embodiments of the invention that are shown in the figures, the cavities 24 extend in the direction of the axis of rotation A. In another embodiment that is not shown, the cavities extend in the form of a helix whose axis is the axis of rotation A.

In the embodiments shown in the figures, the magnets 23 are formed by a succession of elementary magnets. In another embodiment of the invention that is not shown, each magnet 23 is in one piece. In another embodiment of the invention that is not shown, at least one magnet is in one piece and at least one magnet is composed of elementary magnets.

The first end disk 16 comprises a first discoid part 20 from which the first blades 18 extend. The first discoid part 20 may comprise openings for example for reducing the inertia of the rotor.

The first blades 18 are for example formed integrally with the first discoid part 20. The first end disk is for example produced by molding from an aluminum alloy or from plastics material such as a thermoplastic or a thermoset.

The first blades 18 are for example inclined so as to form, with the first discoid part 20, a fan referred to as forward curved fan, as in the embodiments shown in the figures. In another embodiment that is not shown, the first blades are inclined in an opposite direction so as to form, with the discoid part, a fan referred to as backward curved fan. In another embodiment that is not shown, the first blades are radial.

The rotor may also comprise a second end disk 17. The clamping means 25 presses the second end disk 17 directly or indirectly against the second end 34 of the body 15 of the rotor 3.

The second end disk 17 comprises a second number of second blades 19 that are able to move a fluid, notably air, from a third radially inner position to a fourth radially outer position.

The second end disk 17 comprises a second discoid part 21 from which the second blades 19 extend. The second discoid part 21 may comprise openings for example for reducing the inertia of the rotor.

The second blades 19 are for example formed integrally with the second discoid part 21. The second end disk 17 is for example produced by molding from an aluminum alloy or from plastics material such as a thermoplastic or a thermoset.

The second blades 19 may be inclined so as to form, with the second discoid part 21, a fan referred to as forward curved fan, as in the embodiments shown in the figures. In another embodiment that is not shown, the second blades are inclined in an opposite direction so as to form, with the second discoid part, a fan referred to as backward curved fan. In another embodiment that is not shown, the second blades are radial.

In the embodiments shown in the figures, the first number of first blades 18 and the second number of second blades 19 are different. For example, the first number and the second number are not of common divisor. For example, the first number is 9 and the second number is 7.

In another embodiment that is not shown, the first and/or the second blades are distributed circumferentially in an irregular manner.

In another embodiment that is not shown, the first number and the second number are different and the first blades and the second blades are distributed circumferentially in an irregular manner. The first end disk 16 has a first thickness E1 in the direction of the axis of rotation A. The first discoid part 20 has a second thickness D1 in the direction of the axis of rotation A. The ratio between the second thickness D1 and the first thickness E1 is for example between 0.2 and 0.6. The first end disk 16, notably the first discoid part 20, is thus for example be machined, notably pierced, to balance the rotor 3.

The second end disk 17 has a third thickness E2 in the direction of the axis of rotation A. The second discoid part 21 has a fourth thickness D2 in the direction of the axis of rotation A. The ratio between the fourth thickness D2 and the third thickness E2 is for example between 0.2 and 0.6. The second end disk 17, notably the second discoid part 21, is thus able to be machined, notably pierced, to balance the rotor 3.

The first blades 18 of the first end disk 16 and the second blades 19 of the second end disk 17 are for example situated axially, that is to say in the direction of the axis of rotation A, at the winding overhangs 10 of the winding 8. Such a position allows the winding overhangs to be cooled by the fluid that is moved by the blades 18, 19.

In the first embodiment of the invention that is shown in FIG. 1, FIG. 2 and FIG. 3, the shaft 4 comprises a shoulder 14 against which the second end of the body abuts in the direction of the axis of rotation A. The abutment may be indirect as in the first embodiment of the invention in which the second end disk 17 acts as interface between the body 15 and the shoulder 14. In another embodiment that is not shown, the abutment is direct. The body is clamped between the clamping means 25 and the shoulder 14.

In the first embodiment of the invention, the clamping means is a nut 25. The nut 25 is screwed onto a threaded zone 25 of the shaft 4. A clamping force of the nut 25 is thus transmitted by the nut 25 to the first end washer 16 and then to the body 15.

In the first embodiment, the shoulder 14 is formed integrally with the shaft 4.

In another embodiment that is not shown, the shoulder is attached to the shaft 4.

The shaft 4 may comprise a groove 26 in which a key designed to prevent the rotation of the body with respect to the shaft may engage. In the first embodiment, this key is formed integrally in the body 15. The key is then a first protrusion 28 in the central opening of the body 15. The protrusion is oriented radially toward the inside of the body 15.

A second protrusion 27, similar to the first protrusion 28, may be formed in the first end disk 16 so as to prevent the rotation of the first end disk 16 with respect to the shaft 4.

A third protrusion 29, similar to the second protrusion 27, may be formed in the second end disk 17 so as to prevent the rotation of the second end disk 17 with respect to the shaft 4.

The second embodiment of the invention that is shown in FIG. 4 and FIG. 5 is similar to the first embodiment of the invention. However, in the second embodiment, the clamping means and the connection between the shaft 4 and the body 15 of the rotor 3 are different.

The clamping means may comprise a shank 30, notably a threaded shank parallel to the axis of rotation A, passing through a first hole 38 formed in the body.

A second hole 35 formed in the first end disk 16 and a third hole 36 formed in the second end disk 17 are also passed through by the shank 30. Thus the body 15 is clamped between the first end disk 16 and the second end disk 17.

A plurality of shanks 30 may be used as in the second embodiment of the invention. In this embodiment, the shank 30 is the shank of a screw. A nut 31 is screwed onto the shank 30 of the screw so as to clamp the body 15, the first end disk 16 and the second end disk 17 between a head 37 of the screw and the nut 31. In the embodiment shown in FIG. 4 and FIG. 5, the head 37 of the screw abuts directly against the first end disk 16. In another embodiment that is not shown, the abutment between the head 37 of the screw and the first balancing disk is indirect, notably through the use of a washer. Likewise, the abutment between the nut 31 and the second end disk 17 may be direct or indirect, notably through the use of a washer.

In another embodiment of the invention that is not shown, the head of the screw is in direct or indirect contact with the second balancing disk and the nut is in direct or indirect contact with the first balancing disk.

The body is for example force-fitted on the shaft so as to ensure axial holding of the body 15, of the first end washer 16 and of the second end washer 17 on the shaft 4. A rotational connection between the body 15 and the shaft 4 may also be ensured by this force fit. In the second embodiment of the invention that is shown in FIG. 4 and FIG. 5, a groove 26 on the shaft 4 and a first protrusion 28, as in the first embodiment, makes it possible to reinforce the rotational connection between the body 15 and the shaft 4.

In the second embodiment, a shoulder 14 may be formed on the shaft 4 as in the first embodiment. However, this shoulder has a different function. It allows the axial positioning of the rotor body on the shaft during the force-fitting operation.

In a variant of the second embodiment that is not shown, a shoulder formed on the shaft is interposed in clamped fashion in the direction of the axis of rotation between the body and the second end disk. The clamping is for example effected by virtue of the clamping means of the second embodiment described above.

In the various embodiments of the invention described above, the rotary electric machine 1 may be cooled by a cooling liquid. For example, a chamber for the circulation of the cooling liquid is formed in the spacer 7. The casing 32 may then be closed, that is to say that the casing 32 does not comprise any openings for the circulation of ambient air between the inside and the outside of the rotary electric machine 1. The first blades 18 and, where appropriate, the second blades 19 enable, for example, mixing of the air inside the rotary electric machine 1. Measurements have shown that such mixing can reduce the temperature of the winding overhangs 10 by 12° C. and the temperature of the rotor 3 by 4° C.

In an alternative, the rotary electric machine 1 is cooled by a cooling liquid, for example oil, which circulates inside the casing. The first blades 18 and, where appropriate, the second blades 19 promote the circulation of the cooling liquid in the rotary electric machine 1. The rotary electric machine 1 may be connected to a cooling circuit.

In an alternative, the casing of the rotary electric machine 1 has openings. The first blades 18 and/or the second blades 19 promote the circulation of ambient air between the inside and the outside of the rotary electric machine 1.

1. A rotor for a rotary electric machine having an axis of rotation and comprising:
a body comprising cavities and comprising a first end and a second end that are opposite to each other in the direction of the axis of rotation A,
magnets received in the cavities,
a shaft on which the body is mounted,
a first end disk comprising a first number of first blades that are able to move a fluid, notably air, from a first radially inner position to a second radially outer position, the first end disk preventing the magnets from exiting the cavities via the first end of the body,
a clamping means pressing the first end disk directly or indirectly against the first end of the body.

2. The rotor as claimed in claim 1, comprising a second end disk, the clamping means pressing the second end disk directly or indirectly against the second end.

3. The rotor as claimed in claim 2, wherein the second end disk comprises a second number of second blades that are able to move a fluid, notably air, from a third radially inner position to a fourth radially outer position.

4. The rotor as claimed in claim 3, wherein the first number of first blades and the second number of second blades are different and/or the first blades and/or the second blades are distributed circumferentially in an irregular manner.

5. The rotor as claimed in claim 1, wherein the first end disk comprises a first discoid part from which the first blades extend, the first blades notably being formed integrally with the first discoid part.

6. The rotor as claimed in claim 5, wherein the first end disk has a first thickness in the direction of the axis of rotation and the first discoid part has a second thickness in the direction of the axis of rotation, the ratio between the second thickness and the first thickness being between 0.2 and 0.6.

7. The rotor as claimed in claim 3, wherein the second end disk comprises a second discoid part from which the second blades extend, the second blades notably being formed integrally with the second discoid part.

8. The rotor as claimed in claim 7, wherein the second end disk has a third thickness in the direction of the axis of rotation and the second discoid part has a fourth thickness in the direction of the axis of rotation, the ratio between the fourth thickness and the third thickness being between 0.2 and 0.6.

9. The rotor as claimed in claim 1, wherein the shaft comprises a shoulder against which the second end of the body abuts directly or indirectly in the direction of the axis of rotation A, the body being clamped between the clamping means and the shoulder.

10. The rotor as claimed in claim 9, wherein the shaft comprises a threaded zone and the clamping means is a nut screwed onto the threaded zone.

11. The rotor as claimed in claim 1, wherein the clamping means comprises a shank, notably a threaded shank parallel to the axis of rotation A, passing through a hole formed in the body.

12. The rotor as claimed in claim 1, wherein the cavities are closed in a section perpendicular to the axis of rotation.

13. The rotor as claimed claim 1, wherein the cavities are disposed in pairwise fashion in the form of a V.

14. An electric machine comprising:
a. a stator,
b. a rotor as claimed in claim 1.

15. The rotor as claimed in claim 2, wherein the first end disk comprises a first discoid part from which the first blades extend, the first blades notably being formed integrally with the first discoid part.

16. The rotor as claimed in claim 4, wherein the second end disk comprises a second discoid part from which the second blades extend, the second blades notably being formed integrally with the second discoid part.

17. The rotor as claimed in claim 2, wherein the shaft comprises a shoulder against which the second end of the body abuts directly or indirectly in the direction of the axis of rotation A, the body being clamped between the clamping means and the shoulder.

18. The rotor as claimed in claim 2, wherein the clamping means comprises a shank, notably a threaded shank parallel to the axis of rotation A, passing through a hole formed in the body.

19. The rotor as claimed in claim 2, wherein the cavities are closed in a section perpendicular to the axis of rotation.

20. The rotor as claimed claim 2, wherein the cavities are disposed in pairwise fashion in the form of a V.
